(19) United States
(12) Patent Application Publication
(10) Pub. No.: US 2024/0366347 A1
(43) Pub. Date: Nov. 7, 2024

(54) BLOCK MACHINABLE BY CAD/CAM FOR THE MANUFACTURE OF A DENTAL PROSTHETIC ELEMENT, IN PARTICULAR A FIBRE INLAY CORE

(71) Applicant: SOCIETE DE RECHERCHES TECHNIQUES DENTAIRES, SAINT EGREVE (FR)

(72) Inventor: Manh-Quynh CHU, FONTANIL CORNILLON (FR)

(21) Appl. No.: 18/563,614

(22) PCT Filed: May 27, 2021
(86) PCT No.: PCT/FR2021/050966

§ 371 Date: Nov. 22, 2023

(51) Int. Cl. A61C 13/00; A61C 13/20

(52) U.S. Cl. CPC A61C 13/0022; A61C 13/206

(57) ABSTRACT

Block for CAD/CAM machining of dental prosthetic elements such as crowns, composite bridges, inlay-cores (post+abutment), posts, implant abutments, comprising —an insert in which said prosthetic element is machined, —a polymeric layer covering at least one surface of said insert, —a mandrel integral with the polymeric layer, characterized in that the mandrel is made of a material identical to that of the polymeric layer and in that the mandrel and the polymeric layer are cross-linked.

### FIELD

The subject-matter of the invention is a block for CAD/CAM machining or, more generally, a CAD/CAM-machinable support block for the manufacture of dental prosthetic elements such as crowns, bridges, inlay-cores (post+abutment), posts, implant abutments. It also relates to a process for manufacturing said block.

### BACKGROUND

The machining of dental prosthetic elements, specifically crowns and bridges by CAD/CAM (Computer-Aided Manufacturing Design) from preforms is perfectly known. This technology, also called CAD/CAM, has for example been described in document EP 040165 B1. Technology has since evolved, both in terms of CAD/CAM equipment and in terms of the composition of the preforms.

There are essentially 2 types of preforms.

The first type comes in the form of “blocks” with a generally parallelepiped shape. In this case, the blocks are fixed to the articulated arm exposing the preform to the machining tool, by means of a mandrel secured to the block. It is this type of preform that the invention relates to.

The second type of preform is in the form of a “disc” within which the prosthetic elements are machined. In this case, the disc does not have a specific arrangement allowing it to be fixed on the articulated arm. It is simply positioned in a molded recess in the articulated arm.

The invention will subsequently be more particularly described in relation to a CAD/CAM block used 0 the manufacture of fiber inlay cores.

The inlay-core is a one-piece component consisting of a post topped by a false stump. It is made of metal, more rarely of ceramic. It is made from a single piece, which is why it is called “inlay-core or post & core”. It is therefore made of the same material. The inlay-core serves as a support for a depulped tooth reconstruction.

In terms of manufacturing, metal inlay-cores can be obtained by the so-called lost-wax casting technique in the prosthesis laboratory or more rarely by CAD/CAM machining from steel or titanium discs.

There are also fiber inlay cores, which can be machined from discs of the type mentioned previously and as described in document EP 16 798 238, in which cells are formed. Each cell is filled with a composite material into which vertical fibers are embedded. The CAD/CAM machine machines the inlay core directly from the composite material.

Composite posts and inlays can also be produced from CAD/CAM blocks. In this case, the insert in which the inlay core is machined (hereinafter referred to as the “insert”) must be attached to a metal mandrel. To do this, the metal mandrel is glued to one of the insert's surfaces.

The industrial manufacture of these blocks makes machining an expensive solution. The inserts must first be coated with resin, then glued to machined metal mandrels. The cost of the metal mandrel, typically made of brass, aluminum, or stainless steel, combined with the numerous manufacturing steps, leads to high production costs. Furthermore, the blocks available on the market have standard sizes, for example 14 mm×18 mm×14 mm (width×length×height). These blocks are used both for making crowns and posts. However, to the extent that a crown occupies a much larger volume than that of a post, there is excessive overconsumption of material in the case of manufacturing a post and therefore unnecessary additional cost.

Document WO 2009/070470 A1 describes a crosslinkable preform for CAD/CAM machining. The preform includes an insert made of two SMC (self-supporting, malleable, and curable) materials corresponding to the composition of dentin and enamel. The block is supplied with a shank which can take the form of a mandrel, which can then be cross-linked for machining after attaching the block to a machine. The rod is supplied separately and is probably attached to the block by any known means, making the product complicated to handle. Nothing is indicated regarding the material of which the upper is made.

### SUMMARY

Consequently, the problem which the invention sets out to solve is that of developing a CAD/CAM block which can be attached to the CAD/CAM machining center by means of a chuck, which does not have the above-mentioned disadvantages, and in particular which is easy to manufacture and is therefore inexpensive.

The second problem that the invention proposes to solve is that of developing a CAD/CAM block of standard size but whose content of material constituting the insert depends on the prosthetic element to be manufactured.

The Applicant has developed a dental CAD/CAM machining block for a prosthetic element in which the mandrel and insert embedding material are made from a single cross-linked material.

More specifically, the invention relates to a block for CAD/CAM machining of a dental prosthetic element comprising:
an insert in which said prosthetic element is machined,
a polymeric layer covering at least part of the surface of said insert,
a mandrel secured to the polymeric layer.

The block is characterized in that the mandrel is made of a material identical to that of the polymeric layer and in that the mandrel and the polymeric layer are crosslinked.

The term, “identical material”, refers to a material which has the same composition as that of the polymeric layer.

In practice, said material is a thermosetting polymer, advantageously chosen from the group comprising polyurethane (PU), methacrylic resins, or a thermoplastic polymer chosen from the group comprising polycarbonate (PC), polyoxymethylene, or polyacetal, (POM) polymethylmethacrylate (PMMA), polyurethane (PU), polyamide (PA). This list is not exhaustive, as other polymers can be used which are both mechanically resistant to chuck breakage and compatible with dental applications. Advantageously, the polymers above and in particular PC, PMMA, PU, or PA are reinforced by random fibers, for example glass fibers. Preferably, the random fibers represent 10 to 50% by weight, advantageously 30% by weight of the material.

These inserts can be cylindrical, cubic, or rectangular parallelepipedic in shape, depending on the desired application.

According to an essential characteristic, the CAD/CAM block of the invention comprises an insert of which at least part of the surface is covered with a crosslinked polymeric layer.

In a preferred embodiment, in particular when the insert is of cubic or rectangular parallelepipedic shape, at least the surface of the insert, called the “emerging face” is not covered with the polymeric layer. In practice, the emerging surface is the surface opposite the face of the insert upon which the mandrel is fixed, the latter being covered, according to the invention, with a cross-linked polymeric layer.

In an advantageous embodiment, the insert is of cubic or rectangular parallelepiped shape and has only 1 face covered with the polymeric layer, namely the face from which the mandrel emerges. This embodiment is particularly suitable for the manufacture of crowns or bridges which require a large volume of material constituting the insert.

In another embodiment, the insert is of cubic or rectangular parallelepiped shape and has 2 faces covered with the polymeric layer, respectively the surface from which the mandrel emerges, and 1 surface extending one side of the surface from which the mandrel emerges. This embodiment is particularly suitable for the manufacture of posts, inlay cores, or implant abutments which require a smaller volume of material constituting the insert than for the manufacture of crowns or bridges. The insert is therefore coated with a higher polymeric layer content than in the preceding embodiments, and contains a lower content of the insert's constituent material, thus reducing cost compared with blocks of the prior art.

In another embodiment, the entire surface of the insert is covered by the polymeric layer. This may particularly be the case when the insert is cylindrical in shape. Preferably, the mandrel is positioned in a direction orthogonal to that of the cylinder axis. Given the smaller volume of the insert, this embodiment will also be more suitable for the manufacture of posts, inlay cores and implant abutments.

In all cases, the polymeric layer is advantageously overmolded onto the insert.

In practice, excluding the mandrel, the polymeric layer represents between 10 and 50% by weight of the total weight of the block.

The insert may be made of metal or preferably of a composite material.

The invention also relates to the use of the block previously described for machining dental prosthetic elements such as crowns, bridges, inlay-cores (post+abutment), posts, implant abutments.

In a first embodiment, the block of the invention is used for machining crowns and bridges. In this case, the composite material insert is typically composed of polymers, in particular methacrylic resins, advantageously crosslinked, reinforced by fillers such as silica, ceramic glass, radiopaque particles taken alone or in combination, well known in the dental field. These reinforcing fillers can represent up to 85% by weight of the insert. In practice, these inserts are manufactured by molding.

In the case of fiber inlay-core, fiber post, implant abutment, the composite material is composed of polymers in particular of the epoxy, polyester, vinyl ester type, methacrylic resin reinforced by long unidirectional fibers in particular glass fibers, quartz, silica, XRO, or generally any high mechanical performance fibers. These fibers can represent up to 85% by weight of the insert material. In this case, the insert is made from profiles obtained, for example, by the pultrusion technique leading to cross-linked products. The cylindrical, square, or rectangular section profiles are then cut into several sections according to the desired height for the block.

Whatever the type of insert, they then advantageously undergo a mechanical treatment such as sandblasting and machining in order to obtain a rough surface favoring adhesion with the polymeric layer. If necessary, a physicochemical treatment such as plasma-silanization can be applied to the inserts.

The invention also relates to a method of manufacturing the CAD/CAM block as previously described.

This process comprises the following steps:
preparing a mold having 2 hollow parts respectively a first part advantageously of cubic or parallelepiped shape extending on one of its sides by a second part in the shape of the mandrel,
positioning the insert previously manufactured in the first part,
injecting a polymeric material into the mold,
crosslinking the polymeric material,
unmolding the block.

In a first embodiment, the insert is positioned in the center of the first part and the material is injected into the entire remaining volume of the first part and into the entire volume of the second part. Under these conditions, the entire surface of the insert is covered with polymeric material. The insert can be parallelepiped or cylindrical in shape.

In a second embodiment, the insert is of generally parallelepiped shape and the material is injected into only part of the volume of the first part and into the entire volume of the second part. Under these conditions, the insert is positioned in the first part of the mold so that the polymeric material covers at least the face of the insert from which the mandrel emerges.

The inserts are advantageously inserts made of composite materials as described above.

### BRIEF DESCRIPTION OF THE DRAWINGS

The invention and its advantages will become clear from the following examples, in support of the appended figures.

FIG. 1 is a representation of the block of the invention according to a first embodiment.

FIG. 2 is a representation of the block of the invention according to a second embodiment.

FIG. 3 is a representation of the block of the invention according to a third embodiment.

### DETAILED DESCRIPTION

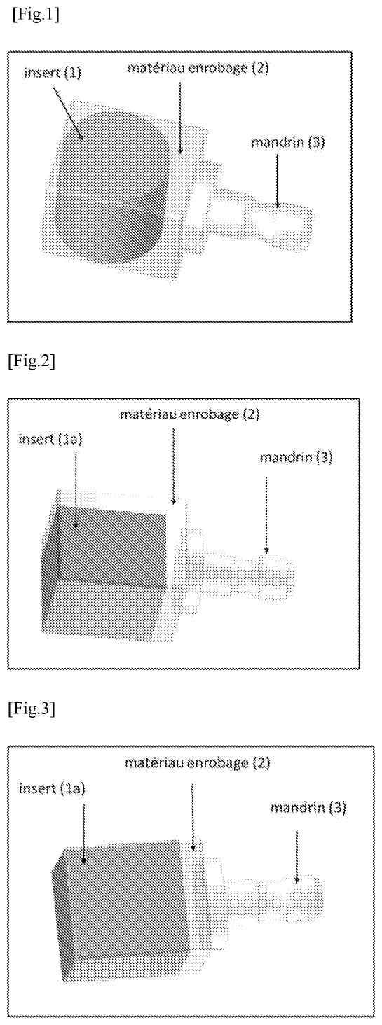

FIG. 1 shows block for CAD/CAM machining of a dental prosthetic element according to the invention. It consists of an insert (1) in the form of a cylinder, a cross-linked polymer layer (2), for example made of PMMA, and a mandrel (3). The polymeric layer covers the entire surface of the insert and forms a cube. The mandrel (3) is made of a material identical to that of the polymeric layer.

The insert is made of polymers such as epoxy, polyester, vinylester, or methacrylic resin, reinforced with long unidirectional fibers such as glass, quartz, silica, or XRO. The insert is made from pultruded profiles. The cylindrical, square, or rectangular section profiles are then cut into several sections according to the desired height for the block.

The manufacturing method is as follows:
a mold is prepared with 2 respective hollow parts, a first part of the cubic shape extending on one of its sides by a second part in the shape of the mandrel,
the previously manufactured cylindrical insert is positioned in the center of the first part,
a polymeric material is injected into the mold to fill the remaining volume of the first part and the entire volume of the second part,
the polymeric material is cross-linked,
the block is removed from the mold.

Under these conditions, the overmold formed by the polymeric layer is cubic in shape. The block thus obtained is particularly suitable for the manufacture of posts, inlay cores and implant abutments for which the quantity of material constituting the insert is less.

FIG. 2 shows a block according to a second embodiment. It consists of a cube-shaped insert (1a), a cross-linked polymer layer (2), e.g., PC, and a mandrel (3). The polymeric layer covers the surface (first face) of the cube in contact with the mandrel and a surface of the cube extending the first face.

The insert is composed of polymers such as epoxy, polyester, vinyl ester, methacrylic resin, reinforced with long unidirectional fibers such as glass, quartz, silica, XRO The insert is made from pultruded profiles. The square-section profiles are then cut into several sections according to the desired block height.

The manufacturing method is as follows:
a mold is prepared with 2 respective hollow parts, a first part of cubic shape extending on one of its sides by a second part in the shape of the mandrel,
the previously manufactured cubic insert is positioned in the first part of the mold so that the polymeric material covers the 2 aforementioned surfaces of the insert,
a polymeric material is injected into the mold to fill the remaining volume of the first part and the entire volume of the second part,
the polymeric material is cross-linked,
the block is removed from the mold.

The resulting block is particularly suitable for the manufacture of posts, inlay cores and implant abutments, where less insert material is required.

FIG. 3 shows a block according to a third embodiment. It consists of a cube-shaped insert (1a), a cross-linked polymeric layer (2), e.g., PU, and a mandrel (3). Unlike the previous embodiment, the polymeric layer only covers the face of the cube from which the mandrel emerges.

In this case, the composite material insert is typically composed of polymers, in particular methacrylic resins reinforced with fillers such as silica, ceramic glass, radiopaque particles.

The manufacturing method is as follows:
a mold is prepared with 2 respective hollow parts, a first part of cubic shape extending on one of its sides by a second part in the shape of the mandrel,
a polymeric material is injected into the mold to fill the remaining volume of the first part and the entire volume of the second part,
the polymeric material is cross-linked,
the block is removed from the mold.

The resulting block is particularly well-suited to the manufacture of crowns and bridges, where the amount of insert material required is considerable.

The invention and its advantages are clear from the foregoing description. We note in particular the advantage linked to the manufacture of the mandrel in a material identical to that of the polymeric layer covering the insert which makes it possible to drastically reduce costs without altering the handling of the block.

1. A block for CAD/CAM machining of dental prosthetic elements comprising:
an insert in which said prosthetic element is machined,
a polymeric layer covering at least one surface of said insert, and
a mandrel secured to the polymeric layer,
wherein the mandrel is made of a material identical to that of the polymeric layer and in that the mandrel and the polymeric layer are crosslinked.

2. The block according to claim 1, wherein said material is a thermosetting polymer advantageously selected from the group comprising polyurethane (PU), methacrylic resin or a thermoplastic polymer advantageously selected from the group comprising polycarbonate (PC), polyoxymethylene or polyacetal, (POM) polymethylmethacrylate (PMMA), polyurethane (PU), polyamide (PA).

3. The block according to claim 1, wherein the material is reinforced with random fibers, preferably glass fibers.

4. The block according to claim 3, wherein random fibers account for 10 to 50% by weight, advantageously 30% by weight, of the material.

5. The block according to claim 1, wherein the insert is cubic or rectangular parallelepiped-shaped and has 2 surfaces covered with the polymeric layer, respectively a first surface from which the mandrel emerges, and a second surface extending one side of the first surface from which the mandrel emerges.

6. The block according to claim 1, wherein the insert is of cubic or rectangular parallelepiped shape and has only 1 face covered with the polymeric layer, namely a face from which the mandrel emerges.

7. The block according to claim 1, wherein the insert is cylindrical in shape and its entire surface is covered with a polymeric layer.

8. The block according to claim 7, wherein the mandrel is positioned in a direction orthogonal to that of a cylinder axis.

9. The block according to claim 1, wherein the block is used for machining dental prosthetic elements such as crowns, bridges, inlay-cores (post+abutment), posts, implant abutments.

10. The block according to claim 1, wherein a method of manufacturing the block, comprises the following steps:
prepare a mold having 2 hollow parts respectively, a first part of cubic or parallelepiped shape extending on one of its sides by a second part in the shape of a mandrel,
position an insert previously manufactured in the first part,
inject a polymeric material into the mold so as to fill the 2 parts,
crosslink the polymeric material, and
unmold the block.
